(19) United States
(12) Patent Application Publication
(10) Pub. No.: US 2009/0168604 A1
(43) Pub. Date: Jul. 2, 2009

(54) DUAL-RECEIVING ULTRASONIC DISTANCE MEASURING EQUIPMENT

(75) Inventors: Jenq-Shyong Chen, Hsin-Chu (TW); Shuo-Peng Liang, Hsin-Chu (TW); Feng-Ming Ou, Hsin-Chu (TW); Chien-Chun Hua, Hsin-Chu (TW)

Correspondence Address: WPAT, PC, 7225 BEVERLY ST., ANNANDALE, VA, 22003, US

(73) Assignee: INDUSTRIAL TECHNOLOGY RESEARCH INSTITUTE, Hsin-Chu (TW)

(21) Appl. No.: 12/273,008

(22) Filed: Nov. 18, 2008

(30) Foreign Application Priority Data
Dec. 31, 2007 (TW) 096151387

(51) Int. Cl. G01S 3/80

(52) U.S. Cl. 367/125

(57) ABSTRACT

A dual-receiving ultrasonic distance measuring equipment is disclosed, which uses a transmitter and two receivers, one of which serves as an objective and the other as a reference, to perform distance measurement. The transmitter and the reference receiver are fixedly installed on a phase adjusting platform, capable of adjusting a reference phase by fine-tuning the distance between the transmitter and the reference receiver. As the objective receiver is disposed on an object under measurement which is a distance away from the phase adjusting platform, there will be a phase shift due to the propagation of an ultrasonic wave from the transmitter as it is received by the two receivers. And thereby, the distance between the two receivers can be calculated based on the phase shift. The aforesaid ultrasonic distance measuring equipment can be applied in the positioning system of high precision machinery or other non-contact distance measuring system.

### BACKGROUND OF THE INVENTION

1. Field of the Invention

The present invention generally relates to a dual-receiving ultrasonic distance measuring equipment and, more particularly, to a dual-receiving ultrasonic distance measuring equipment using a transmitter and two receivers to measure the phase and calculate the distance between the two receivers based on the phase shift therebetween to overcome the precision issue due to transient state characteristics of a sensor. The distance between the first receiver and the transmitter disposed on a phase adjusting platform can be measured with high precision by fine-tuning the phase adjusting platform to adjust a reference phase and improve the measuring precision using a phase comparator to achieve high-precision ultrasonic wave measurement.

2. Description of the Prior Art

Distance measuring equipments used in general machinery (such as lathes and milling machines), medical equipments and automated apparatuses require high-precision measurement. The systems with high-precision positioning and measurement are costly, because high-directivity but easily disturbed optic systems such as laser are used for micro-meter or sub-micro meter scale measurement that require complicated mechanism. Other systems (such as ultrasonic wave measuring systems) are suffering from poor precision that does not meet the requirement for high-precision measurement. The available ultrasonic wave measuring systems cannot reach micro-meter scale precision when being used during flights or in dual-frequency measurement.

Therefore, there is need in providing a dual-receiving ultrasonic distance measuring equipment to achieve high-precision ultrasonic wave measurement.

### SUMMARY OF THE INVENTION

It is an object of the present invention to provide to a dual-receiving ultrasonic distance measuring equipment using a transmitter and two receivers to measure the phase and calculate the distance between the two receivers based on the phase shift therebetween to overcome the precision issue due to transient state characteristics of a sensor. The distance between the first receiver and the transmitter disposed on a phase adjusting platform can be measured with high precision by fine-tuning the phase adjusting platform to adjust a reference phase and improve the measuring precision using a phase comparator to achieve high-precision ultrasonic wave measurement.

In order to achieve the foregoing object, the present invention provides a dual-receiving ultrasonic distance measuring equipment installed on a fixing platform, the dual-receiving ultrasonic distance measuring equipment comprising:

an ultrasonic transmitter, capable of transmitting an ultrasonic wave signal for distance measurement;

a first receiver, being movable and capable of adjusting the distance between the first receiver and the ultrasonic transmitter; and

a second receiver, being fixed on a position under measurement;

wherein the distance between the first receiver and the second receiver is a distance under measurement calculated based on the phase shift and signal attenuation between the first receiver and the second receiver.

### BRIEF DESCRIPTION OF THE DRAWINGS

The objects, spirits and advantages of the preferred embodiment of the present invention will be readily understood by the accompanying drawings and detailed descriptions, wherein:

FIG. 1 is a functional block diagram showing a dual-receiving ultrasonic distance measuring equipment according to the present invention; and

FIG. 2 is an example of a dual-receiving ultrasonic distance measuring equipment according to the present invention used with a phase comparator for phase analysis.

### DETAILED DESCRIPTION OF THE PREFERRED EMBODIMENT

The present invention can be exemplified but not limited by the preferred embodiment as described hereinafter.

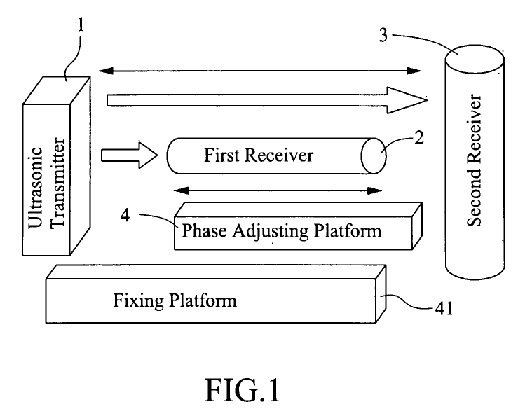

Please refer to FIG. 1, which is a functional block diagram showing a dual-receiving ultrasonic distance measuring equipment according to the present invention. The dual-receiving ultrasonic distance measuring equipment is installed on a fixing platform 41. The dual-receiving ultrasonic distance measuring equipment comprises: an ultrasonic transmitter 1, a first receiver 2 and a second receiver 3. The ultrasonic transmitter 1 is capable of transmitting an ultrasonic wave signal for distance measurement. The ultrasonic transmitter 1 is an ultrasonic wave signal source capable of transmitting single-frequency, multi-frequency or frequency-converted ultrasonic wave signals. The first receiver 2 is movable and capable of adjusting the distance between the first receiver 2 and the ultrasonic transmitter 2. The distance between the ultrasonic transmitter 1 and the first receiver 2 is adjusted by a phase adjusting platform 4 comprising a stepping motor. The phase shift and signal information of the ultrasonic wave signal received by the first receiver 2 can be used for correction and compensation of distance measurement. The second receiver 3 is fixed on a position under measurement.

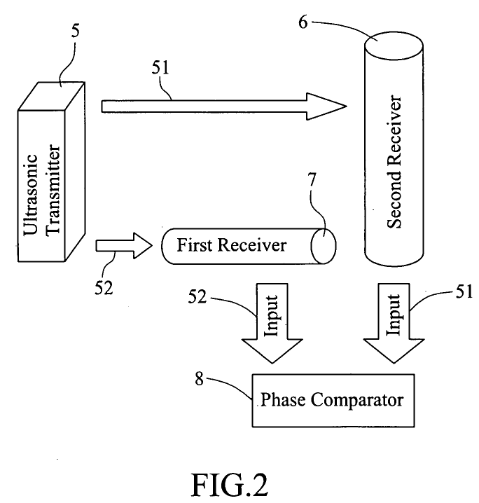

The distance between the ultrasonic transmitter 1 and the first receiver 2 is fine-tuned by a phase adjusting platform 4 so as to adjust the phase of the reference signal and to transmit the signals from the first receiver 2 and the second receiver 3 to a phase comparator (in FIG. 2) to obtain more precise phase information.

In the dual-receiving ultrasonic distance measuring equipment of the present invention, the distance between the first receiver 2 and the second receiver 3 is a distance under measurement calculated based on the phase shift and signal attenuation between the first receiver 2 and the second receiver 3. The distance between the first receiver 2 and the second receiver 3 is measured using a phase meter (not shown).

Please refer to FIG. 2, which is an example of a dual-receiving ultrasonic distance measuring equipment according to the present invention used with a phase comparator for phase analysis. A transceiving probe operating above 400 kHz is used with a driving circuit to form an ultrasonic transmitter 5 to be installed on a phase adjusting platform 4 so as to transmit a first signal 51 and a second signal 52 (the first signal 51 and the second signal 52 have the same ultrasonic frequency). The first signal 51 is received by the second receiver 7, and the second signal 52 is received by the first receiver 6. The reference phase of the ultrasonic transmitter 5 is fine-tuned by the first receiver 6 installed on the phase adjusting platform 4 comprising a stepping motor. Finally, a phase comparator 8 is used to analyze the phase shift between the first signal 51 and the second signal 52. The available phase comparator 8 can achieve the precision of phase analysis to one percent to implement high-precision ultrasonic wave measurement and overcome the precision issue due to transient state characteristics of a sensor.

From FIG. 1 to FIG. 2, it is understood that the present invention uses a transmitter and two receivers, one of which serves as an objective and the other as a reference, to perform distance measurement. The first receiver is fixedly installed on a phase adjusting platform capable of fine-tuning the distance between the transmitter and the two receivers. The second receiver is installed on the object under measurement. Meanwhile, after the ultrasonic wave from the ultrasonic transmitter is received by the two receivers, a phase shift is caused by the difference of distance. The phase shift can be calculated to obtain the distance between the two receivers.

Accordingly, the present invention discloses a dual-receiving ultrasonic distance measuring equipment capable of being applied in the positioning system of high precision machinery or other non-contact distance measuring system. Therefore, the present invention is novel, useful, and non-obvious.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. A dual-receiving ultrasonic distance measuring equipment installed on a fixing platform, the dual-receiving ultrasonic distance measuring equipment comprising:
an ultrasonic transmitter, capable of transmitting an ultrasonic wave signal for distance measurement;
a first receiver, being movable and capable of adjusting the distance between the first receiver and the ultrasonic transmitter; and
a second receiver, being fixed on a position under measurement;
wherein the distance between the first receiver and the second receiver is a distance under measurement calculated based on the phase shift and signal attenuation between the first receiver and the second receiver.

2. The dual-receiving ultrasonic distance measuring equipment as recited in claim 1, wherein the ultrasonic transmitter is an ultrasonic wave signal source capable of transmitting single-frequency, multi-frequency or frequency-converted ultrasonic wave signals.

3. The dual-receiving ultrasonic distance measuring equipment as recited in claim 1, wherein the distance between the ultrasonic transmitter and the first receiver is adjusted by a phase adjusting platform comprising a stepping motor.

4. The dual-receiving ultrasonic distance measuring equipment as recited in claim 1, wherein the phase shift and signal information of the ultrasonic wave signal received by the first receiver can be used for correction and compensation of distance measurement.

5. The dual-receiving ultrasonic distance measuring equipment as recited in claim 1, wherein the distance between the first receiver and the second receiver is measured by a phase comparator.

6. The dual-receiving ultrasonic distance measuring equipment as recited in claim 1, wherein the ultrasonic transmitter comprises a transceiving probe and a driving circuit.
